(19) United States
(12) Patent Application Publication
(10) Pub. No.: US 2010/0134261 A1
(43) Pub. Date: Jun. 3, 2010

(54) SENSORY OUTPUTS FOR COMMUNICATING DATA VALUES

(75) Inventor: Scott M. Heimendinger, Seattle, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/326,122

(22) Filed: Dec. 2, 2008

(51) Int. Cl. G08B 6/00; G08B 3/10

(52) U.S. Cl. 340/407.1; 340/384.5

(57) ABSTRACT

Architecture for communicating data values that enables visually impaired persons to perceive a non-image indicator corresponding to the data values. For example, an organized data set such as a chart or a graph can be displayed on a computer monitor or other user interface output component. A user employs a mouse or other user input component to select a data value from the organized data set. A non-image indicator such as an audible tone can be generated to correspond to the selected data value. A spread of audible tones corresponding to the organized data set is assigned across a range between a maximum data value and a minimum data value. A tonal separation is assigned between audible tones sufficient to enable the user to discern a pitch variation and corresponding change in data value.

### BACKGROUND

Visually impaired persons have a measure of eyesight but cannot perceive a high level of detail as compared with people with fully-functioning eyesight. Thus, visually impaired persons encounter a number of difficulties, especially with using a computer. With the ubiquity of visually-oriented computer-based systems, visually impaired persons can find it increasingly difficult to operate in contemporary society.

For people with functioning vision, viewing data on a chart or graph can be helpful for analyzing trends or observing differences between data points. However, visually impaired persons have difficulty analyzing numeric data presented on a computer monitor. Screen readers are known for helping the visually impaired interact with computers in general and in particular, to read numbers that appear sketchy. Screen readers can convert text on a screen into a simulated voice, thereby allowing an audible “reading” of the text.

However, for visually impaired people, simply hearing numerical values spoken by a screen reader does not contribute to a cognitive appreciation of the relationships between various data points. While listening to a string of numbers, it is difficult to comprehend a trend in those numbers or the proportional relationships between them.

Another problem with presenting numeric data to the visually impaired is conveying differences in numerical values that are small relative to the magnitudes of the numbers. Small differences between data points on a chart or graph are not visually obvious to people even with fully-functioning vision. For example, it can be difficult to visually discern between data points that vary only slightly as viewed on a screen, where such differences can be represented by only one or two pixels. Though difficult, these differences may nevertheless still be discerned by fully sighted persons. However, such small differences are not easily discernable by visually impaired persons.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

To that end, architecture is disclosed for receiving a set of organized data and outputting a range of non-image indicators that correspond to data values (e.g., numerical, alphanumeric, purely alphabetic, etc.) within the organized data set. The organized data can be a chart or a graph or the like displayed on a computer monitor where a user input interface component such as a mouse can be used to select a data value. The non-image indicators can be a range of audible tones that are played according to data values selected from the organized data set. The range of audible tones is calculated across an audible range between a maximum frequency and a minimum frequency. The tonal separation between the audible tones is calculated so that a user can discern a pitch variation between the tones, to distinguish between the associated data values. The range of audible tones can be customized to user requirements (e.g., to represent a particular user's range of audible frequencies).

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates an exemplary computer-implemented system for communicating data values.

FIG. 2 illustrates exemplary aspects of non-image indicators as used with the computer-implemented system for communicating data values.

FIG. 3 illustrates exemplary aspects in which a user interface is employed to select data values.

FIG. 4 illustrates an alternative embodiment of a system for communicating data values.

FIG. 5 illustrates exemplary aspects of an audio component as used with the system for communicating data values.

FIG. 6 illustrates an exemplary method of communicating data values.

FIG. 7 illustrates further exemplary aspects in the method of communicating data values.

FIG. 8 illustrates additional exemplary aspects in a method of communicating data values.

FIG. 9 illustrates an alternative exemplary method of communicating data values.

FIG. 10 illustrates a block diagram of a computing system operable to execute the communication of data values in accordance with the disclosed architecture.

FIG. 11 illustrates an exemplary computing environment operable to provide discernable sensory input for communicating data values.

### DETAILED DESCRIPTION

The disclosed architecture facilitates the communication of data values to visually-impaired users by generating for perception non-image indicators that correspond to the data values. For example, an organized data set such as a chart, a table, or a graph can be displayed on a computer monitor or other user interface output component. A user employs a mouse or other user input mechanism (e.g., cursor movement using a keyboard) to select a data value from the organized data set. One technique for more selective control of high density data points can be to allow the user to select a vertical line that extends the vertical limits of the chart, and which can be moved left or right along the x-axis of a graph, for example, such that the vertical line intersects each data point in a line or curve in the graph. In response thereto, a non-image indicator or signal such as an audible tone is generated that corresponds to the intersecting data point based on the corresponding data value. A spread of audible tones corresponding to the organized data set is assigned across a range between a maximum and a minimum frequency. A tonal separation is assigned between audible tones sufficient to enable the user to discern a pitch variation.

While the data values can typically be numerical, it is within contemplation of the instant architecture that an audible frequency range can be mapped to a spread of alphabetic data values, as well, or any objects that can be ranked or organized according to some arrangement. For example, the frequency range can be mapped to the alphabet of data values A-Z. Thus, if the user selects or navigates among the alphabetic objects, the tones can vary according to a low frequency mapped to the letter A and a high frequency mapped to the letter Z. This capability can then be applied to languages or words, for example.

In an alphanumeric example, a chart may be shown with hexadecimal data values. In this case, the frequency range can be mapped to the spread of hexadecimal values presented.

This can also be applied to a color spectrum that ranges from a higher color frequency (e.g., white) to a lower color frequency (e.g., black). In other words, the architecture can be applied to any ordered arrangement of objects that can be displayed. Although the description will be in the context of viewing numerical data values, it is to be understood that the data values can be associated with any ordered arrangement of objects for which the visually impaired can interact.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

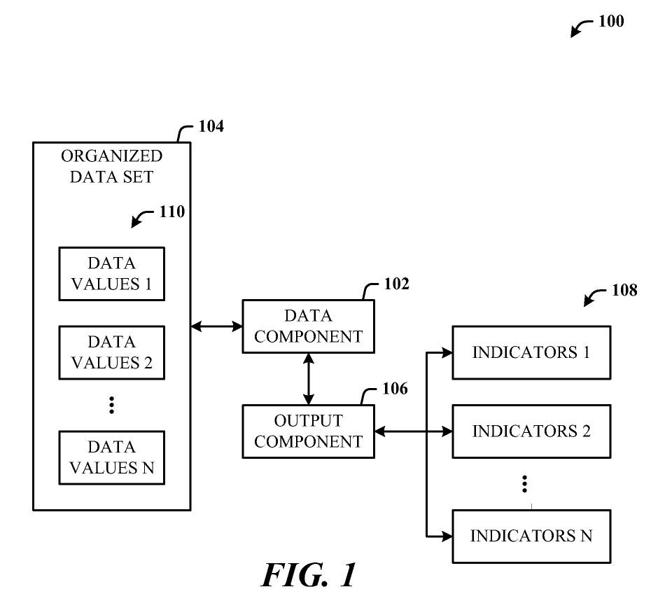

FIG. 1 illustrates a computer-implemented system 100 for communicating data values. The system 100 can be implemented to assist visually impaired persons in interpreting data by producing audible tones corresponding to numerical data values. However, the system 100 can also generally be implemented to produce other types of sensory input that enable non-visual interpretation of numerical data values, such as vibrations, brightness in ambient light, skin pressure, and so on, or combinations thereof.

As illustrated in FIG. 1, the system 100 includes a data component 102 for receiving an organized data set 104. The system 100 also includes an output component 106 for outputting a range of non-image indicators 108 corresponding to numerical data values 110 within the organized data set 104. The output component 106 is configured to assist visually impaired users in interpreting the organized data set 104.

In one aspect, the organized data set 104 can be any type of informational indicia as are typically presented in a visual medium, such as a computer monitor. As described herein, the organized data set 104 can be a table, a bar graph, a pie chart, or other type of data presentation scheme. The organized data set 104 can also be a periodically varying function, such as a sinusoidal function, a sawtooth wave, square wave, or any other type of mathematical function.

In an embodiment of the system 100, the data component 102 and the output component 106 can be part of a software module that resides on a client device. The data component 102 receives the organized data set 104 from software applications residing on the client device. Alternatively, the data component 102 and the output component 106 are part of a software module that resides on a server.

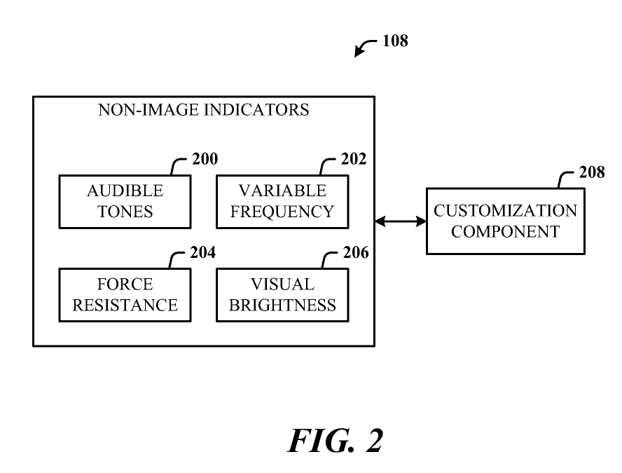

FIG. 2 illustrates exemplary aspects of the non-image indicators 108 as used with the computer-implemented system 100 for communicating data values. The non-image indicators 108 can be represented by a range of audible tones 200, as described in detail hereinbelow. However, the non-image indicators 108 can also be represented by any type of non-visual sensory input. If a visually impaired user is also hearing impaired, non-image indicators 108 can be represented by a variable tactile vibrational frequency 202 where the user can sense frequency vibrations corresponding to the numerical data values.

As also illustrated in FIG. 2, the non-image indicators 108 can be represented by levels of tactile force resistance 204, for example, varying levels of tactic force such as a resistance against an object can be detected by the user. Alternatively, the non-image indicators 108 can be represented by variations in heat, or by varying levels of visual brightness 206, for users that have a low level of visual acuity but can still discern variations in lightness and darkness or a range of color differentiation.

As also illustrated in FIG. 2, a customization component 208 can be included for customizing the range of non-image indicators 108 to a particular user requirement. The customization component 208 can provide adjustable thresholds suited to a user's perceptual abilities. For example, in an embodiment where audible tones are used as non-image indicators 108, an audible range can be customized. For a user having a hearing deficiency in certain audible frequency ranges, or if hearing is more acute than the norm, the range of non-image indicators 108 can be tailored to the hearing thresholds.

The customization component 208 can also include a training sequence where the user can listen to differences between audible tones, and make additional adjustments, if desired. A score of the training sequence can be used to establish a tonal range and minimum discrete steps between audible tones.

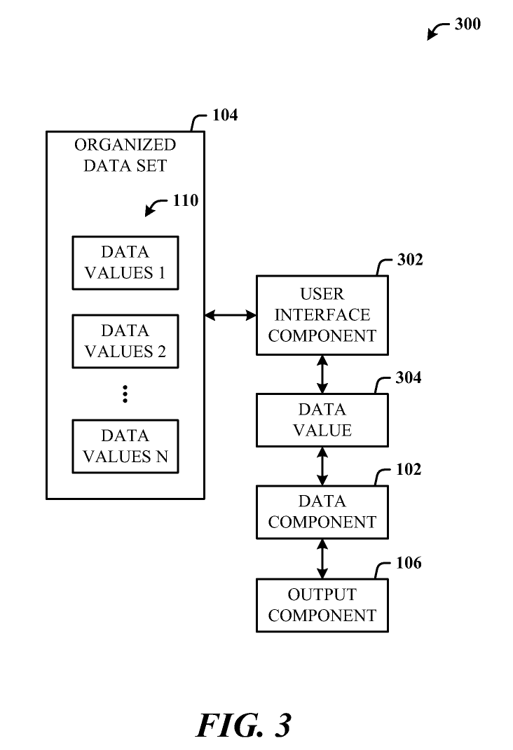

FIG. 3 illustrates exemplary aspects of the system 300 in which a user interface component 302 is employed to select the data values 110. The user interface component 302 presents the data values 110 to the user and allows the user to select a particular data value 304 (e.g., numerical) to be outputted through the output component 106 as a corresponding non-image indicator. The user interface component 302 can be a graphical user interface for selecting the data value 304 from the organized data set 104. The user can interact with the graphical user interface using a mouse for enabling movement of a cursor to select the specific numerical data value 304 represented by a section or portion of a table, graph, chart or other visual representation displayed on the computer monitor.

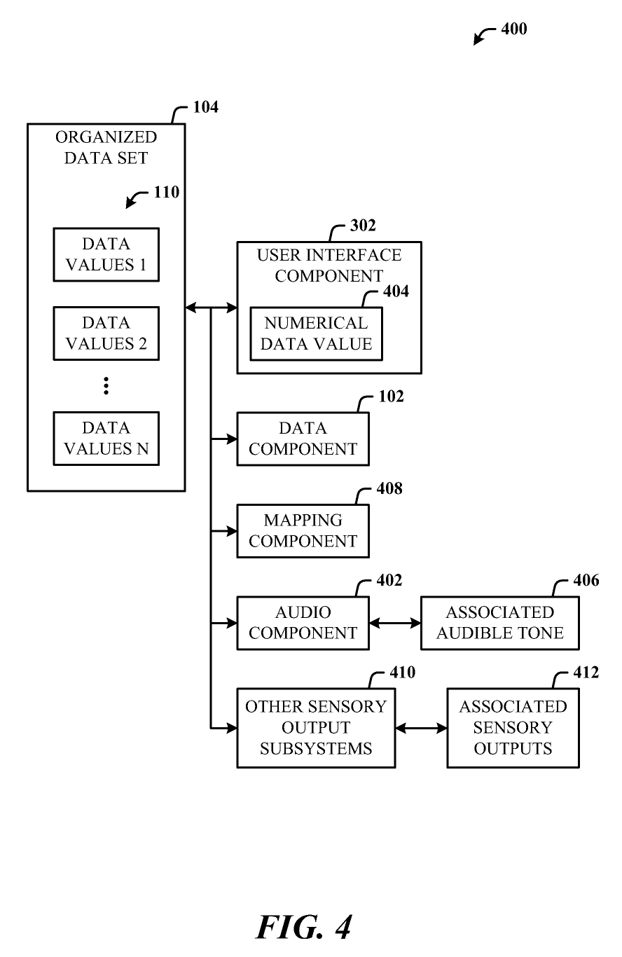

FIG. 4 illustrates an alternative embodiment of a 400 for communicating data values. The data component 102 is included for receiving the organized data set 104. An audio component 402 generates audible tones corresponding to the data values 110 within the organized data set 104. The user interface component 302 is provided for presenting the organized data set 104 and selecting a numerical data value 404 to be converted into an associated audible tone 406.

The audio component 402 can generate audible tones in any desired frequency range. For example, the audible tones can correspond to a range of musical notes selected from an 88-key piano keyboard. In contrast to a previous type reader system that only reads numerals aloud, the data values 110 can be represented as a variety of different types of audio tones, such as sound effects or the like.

The system 400 can further include a mapping component 408 for mapping the data values to the range of non-image indicators. The mapping can be based on the highest and lowest data values in the data set, or over a predetermined upper and lower limit in which the highest and lowest data values reside.

In one aspect, the higher the frequency of the audible tone, the higher the numerical value. As a number of the numerical data values 110 are sequentially heard by the user, a tonal sequence can be perceived that can, for example, be heard to increase or decrease in frequency, or fluctuate over an audible scale (e.g., so that a “song” can “played” corresponding to the presented data.) Additionally, for a sinusoidal function, the sound level can be perceived to increase and decrease in volume at respective high and low points. For a sawtooth function, the audible tone can rise linearly in frequency and then sharply drop, corresponding to the shape of the plotted function. This mode of presentation can help someone with visual impairment understand a trend in presented data values.

As used with a graphical user interface, a user employs a computer mouse to hover a cursor over a data point in a table, chart or graph. The audio component 402 produces an audio tone that corresponds to the value of the data point. A range of the tones (from lowest to highest) is calculated by the system 400 based on the minimum and maximum data values. In one embodiment, larger data values can produce higher tones and smaller data values can produce lower tones.

As previously indicated, other types of outputs can be employed that can be sensed by the visually impaired user. Other sensory output subsystems 410 can be employed to provide associated sensory outputs 412. For example, a vibration subsystem can be provided that outputs changes in vibration based on corresponding changes in the data values selected (or hovered over). Another example is a light control subsystem that can adjust the brightness of the display, for example, or ambient room light, based on a corresponding change in data values (e.g., brighter for increasing data values, dimmer with decreasing data values, etc.).

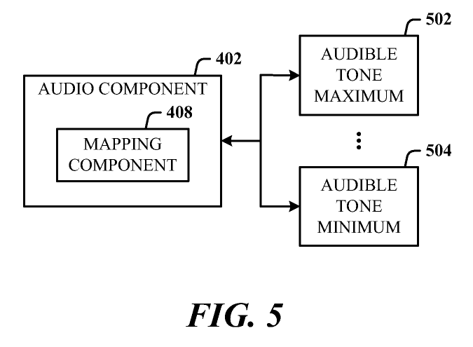

FIG. 5 illustrates exemplary aspects of the audio component 402 as used with the system 400 for communicating data values. The audio component 402 includes a mapping component 408 for mapping audible tones across a range between an audible tone maximum 502 and an audible tone minimum 504. The mapping component 408 can also assign a threshold of a tonal separation between audible tones sufficient for the user to discern a variation in pitch. For example, the separation can be that associated with the difference between a middle C to D on a piano keyboard, or middle C to E, etc. In another example, the mapping of the data values can be applied from the lower band edge to the upper band edge of the typical human audible range (e.g., 20 Hz-20 kHz). In yet another example, the number of data values can be mapped across a subset of the audible range such as 1 kHz to 10 kHz. Note that the audible tone maximum 502 and an audible tone minimum 504 can be in the context of volume (higher data value equates to higher volume), rather than pitch, or a combination of a change in volume level and a change pitch.

A visually-oriented table, chart, or graph displayed on a monitor can present differences that are small in magnitude compared to the size of the numerical values 110 (e.g., differences of one or two pixels on a chart). However, such minor differences can be represented by specific audible tones by selecting suitable thresholds of tonal differences. For example, a suitable algorithm can define a spread to have a threshold for stepping tonal levels up or down so that a user can hear the tonal differences even though small differences are not easily viewed on the display.

In an exemplary embodiment, a visually impaired user opens a spreadsheet that includes a bar graph illustrating the total sales of a company for the past thirty-six weeks. As a user-driven cursor gives focus to each bar on the graph, a tone is played through the computer speakers. The tones are based on MIDI (musical instrument digital interface) instruments, for example, a xylophone, and the data ranges from 1 to 1000 for the chart the user has opened. When the user moves the focus to the lowest data point (1), a tone of a frequency of 27.5 Hz (corresponding to the lowest note on a standard piano) is played. When the mouse hovers over the highest data point (1000), a tone having a frequency of 4186.01 Hz (corresponding to the highest note on a standard piano) is played.

In an exemplary embodiment, the frequency of each audible tone can be represented as a sum of a minimum audible tone frequency and a maximum audible tone frequency divided by an offset, to produce a normalized value between minimum and maximum. The following formula can be employed to determine the frequency of a note to be played:

$${F}_{x} = {F}_{min} + \frac{{F}_{max}}{( {x}_{max} - {x}_{min} )} \times ( x - {x}_{min} )$$

where Fₓ is the frequency corresponding to a numerical data value x; Fₘᵢₙ is the minimum frequency playable, determined by the spread (indicated below); Fₘₐₓ is the maximum frequency playable, determined by the spread (indicated below); xₘₐₓ is the largest data value of x; and, xₘᵢₙ is the smallest data value of x.

The Fₘᵢₙ and Fₘₐₓ values indicated above are set according to the spread (the highest and lowest values) of the data, as determined by the mapping component 408. This spread, which measures the relative differences between data values can be given as:

$$Spread = \frac{\sqrt{\frac{1}{n} ( {\sum }_{i = 1}^{n} {x}_{i}^{2} - n {\overline{x}}^{2} )}}{\overline{x}}$$

where x is a particular numerical data value; n is the number of numerical data values in the spread; and, x̅ is the mean of all numerical data values n in the spread.

In an exemplary embodiment, where a spread is based on an 88-key piano, the upper limit of the spread approaches 3.163 while the lower limit of the spread approaches zero. As the value of the spread approaches 3.163, Fₘᵢₙ approaches 27 Hz and Fₘₐₓ approaches 4186.01 Hz. As the value of the spread approaches zero, Fₘᵢₙ approaches 261.626 Hz and Fₘₐₓ approaches 523.251 Hz (i.e., the octave starting at middle C on a standard piano). It is to be appreciated that any tonal spread can be defined, not limited to the range of an 88-key piano. It is also to be appreciated that the larger the spread, the greater number of tonal differentiations can be used over the audible range. Conversely, a small number of numerical data values can be represented by a small spread. For example, a range of five numerical data values can be represented by the notes DEFGA of a single keyboard octave rather than being spread across the entire piano keyboard.

In one implementation, the audible output can be speech signals so that the user does not need to mentally process pitch. For example, if the user moves the cursor on a first data point to a higher value data point, a voice signal can be output such as “up”. The reverse direction would output a voice signal such as “down”. Other examples include actually using the count or discrete steps derived and applied to the full range to generate voice signals that indicate skipped data points. For example, if the user moves the cursor from a first data point to a third data point, the output voice signal can be “skipped one”, and if moving to a higher value data point the output can be “skipped one up”.

Where the number of data points is large (e.g., 10,000), the mapping can be to pages of data points. For example, each page can be 1000 data points, which can also be the range over which audio tones are applied. Thus, when the user increments one page, the same range and set of audio tones is applied to the new set of 1000 data points.

The instant architecture can also be applied to bipolar graphing where a curve may extend across an axis (e.g., above and below the x-axis). In this instance, the mapping can be applied symmetrically to each segment of the curve above and below the axis. Alternatively, the full range can be computed from the lowest negative value to the highest positive value and audio tones applied over the range. Moreover, if the user crosses the axis, a predefined tone can be output. Continuing with this example, a dual tone can be output for any data point selected below the axis, and a single tone for each data point selected above the axis. As can be seen, the ability to map a non-image output to a data point can be configured and processed in many different ways to provide the visually impaired user a tool to interact with charts and graphs and the data points therein.

The way in which a technique is determined for mapping to data points can be by manual selection or automatic selection. For example, the user can manually select the range over which a span of audio frequencies will be applied. Based on this configuration and selection, if the user can zoom in on a string of data points that were beyond the original resolution for mapping, but are now mappable, the same span of frequencies can be applied to the now zoomed-in range of data points.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

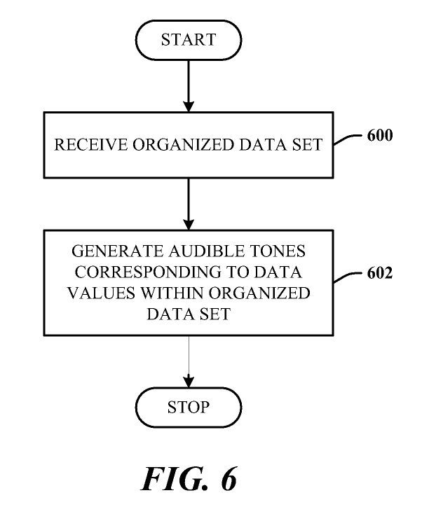

FIG. 6 illustrates a method of communicating data values. At 600, an organized data set is received, where the organized data set can be in the form of a table, graph, chart, or other type of visual informational display presented on a computer monitor. At 602, audible tones are generated that corresponding to data values (e.g., numerical) within the organized data set. The audible tones can be selected from any audible range, such as from an 88-key piano keyboard.

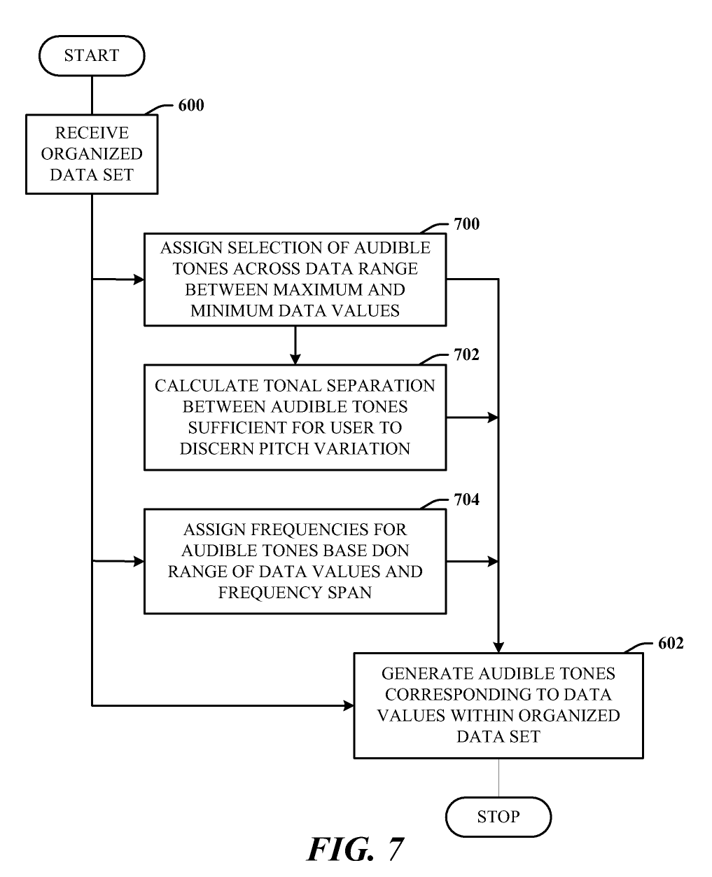

FIG. 7 illustrates further exemplary aspects in a method of communicating data values. At 600, an organized data set is received, where the organized data set can be in the form of a table, graph, chart, or other type of visual informational display presented on a computer monitor. At 700, a selection of audible tones is assigned across a data range between maximum and minimum data values. This can be performed prior to the generating of audible tones at 602, as shown hereinabove. At 702, the assigning of the selection can include calculating a tonal separation between the audible tones sufficient for a user to discern a pitch variation. At 704, frequencies for the audible tones are assigned so that a frequency of each audible tone represents a sum of a minimum audible tone frequency and a maximum audible tone frequency divided by an offset to produce a normalized value between minimum and maximum. This can also performed prior to the generating of audible tones, at 602, as shown hereinabove.

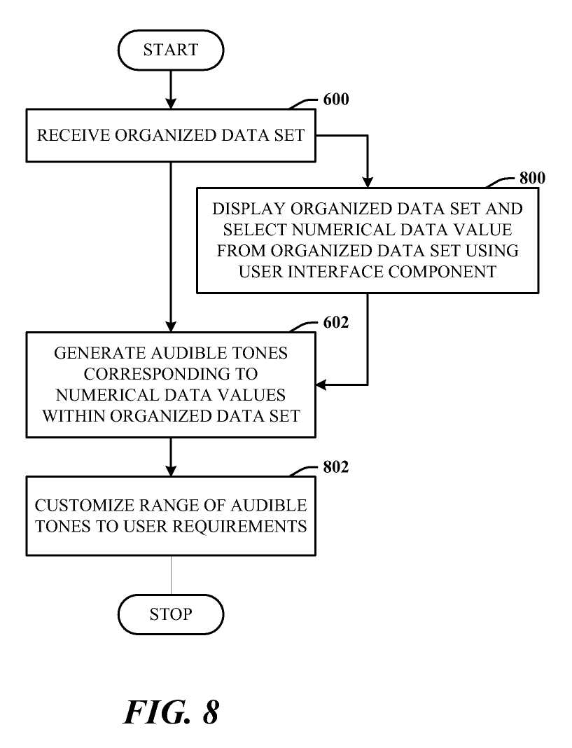

FIG. 8 illustrates additional exemplary aspects in the method of communicating data values. At 600, an organized data set is received. At 800, the receiving of the organized data set can also include displaying the organized data set and selecting a numerical data value from the organized data set using a user interface component. The displaying can be performed prior to the generating of audible tones at 602, as shown hereinabove. At 802, a range of audible tones is customized to user requirements. This can be done if the user has a hearing loss within a frequency range of the standard audible range of human hearing.

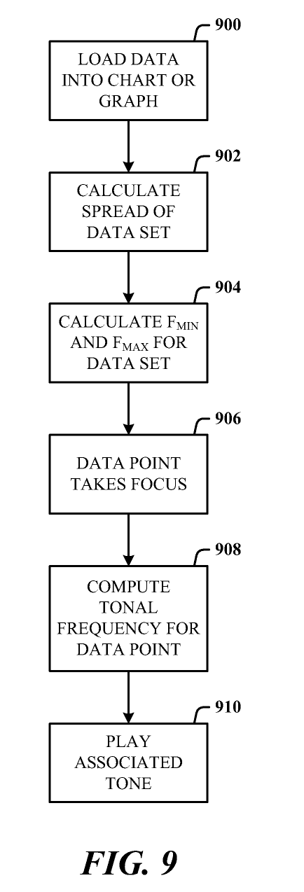

FIG. 9 illustrates an alternative exemplary method of communicating data values. At 900, data is loaded into a chart or graph, in which numerical data values from a data set are presented as a visual chart, for example, on a computer monitor. At 902, a spread of audible tones is calculated to correspond to the numerical data values of the data set. At 904, the values of Fₘᵢₙ and Fₘₐₓ are calculated for the frequencies of the audible tones corresponding to the numerical data values in the data set. At 906, a specific data point (i.e., a numerical data value) takes focus when user moves a cursor over a selected area of the visual chart, for example, a selected bar on a bar graph. At 908, a tonal frequency for the selected data point is computed. At 910, the computed audible tone is played, so that the user can hear a representation of the selected data point.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

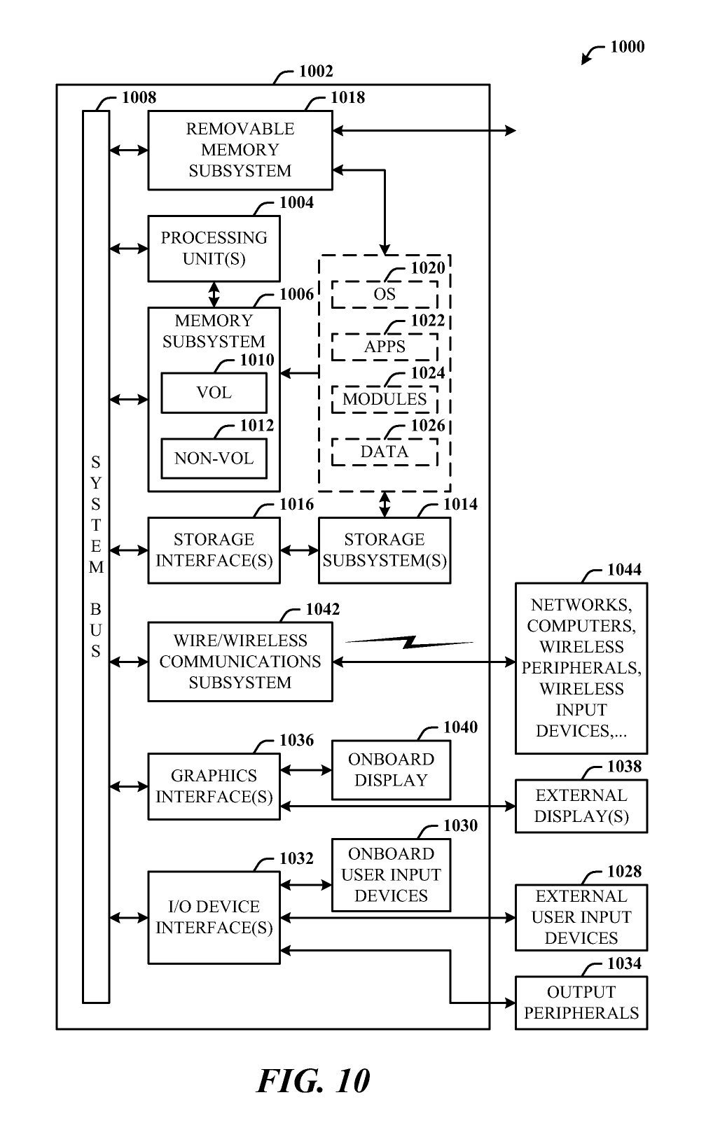

Referring now to FIG. 10, there is illustrated a block diagram of a computing system 1000 operable to execute communicating data values in accordance with the disclosed architecture. In order to provide additional context for various aspects thereof, FIG. 10 and the following discussion are intended to provide a brief, general description of the suitable computing system 1000 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 1000 for implementing various aspects includes the computer 1002 having processing unit(s) 1004, a system memory 1006, and a system bus 1008. The processing unit(s) 1004 can be any of various commercially available processors such as single-processor, multi-processor, single-core units and multi-core units. Moreover, those skilled in the art will appreciate that the novel methods can be practiced with other computer system configurations, including minicomputers, mainframe computers, as well as personal computers (e.g., desktop, laptop, etc.), hand-held computing devices, microprocessor-based or programmable consumer electronics, and the like, each of which can be operatively coupled to one or more associated devices.

The system memory 1006 can include volatile (VOL) memory 1010 (e.g., random access memory (RAM)) and non-volatile memory (NON-VOL) 1012 (e.g., ROM, EPROM, EEPROM, etc.). A basic input/output system (BIOS) can be stored in the non-volatile memory 1012, and includes the basic routines that facilitate the communication of data and signals between components within the computer 1002, such as during startup. The volatile memory 1010 can also include a high-speed RAM such as static RAM for caching data.

The system bus 1008 provides an interface for system components including, but not limited to, the memory subsystem 1006 to the processing unit(s) 1004. The system bus 1008 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 1002 further includes storage subsystem(s) 1014 and storage interface(s) 1016 for interfacing the storage subsystem(s) 1014 to the system bus 1008 and other desired computer components. The storage subsystem(s) 1014 can include one or more of a hard disk drive (HDD), a magnetic floppy disk drive (FDD), and/or optical disk storage drive (e.g., a CD-ROM drive DVD drive), for example. The storage interface(s) 1016 can include interface technologies such as EIDE, ATA, SATA, and IEEE 1394, for example.

One or more programs and data can be stored in the memory subsystem 1006, a removable memory subsystem 1018 (e.g., flash drive form factor technology), and/or the storage subsystem(s) 1014, including an operating system 1020, one or more application programs 1022, other program modules 1024, and program data 1026. Generally, programs include routines, methods, data structures, other software components, etc., that perform particular tasks or implement particular abstract data types. All or portions of the operating system 1020, applications 1022, modules 1024, and/or data 1026 can also be cached in memory such as the volatile memory 1010, for example. It is to be appreciated that the disclosed architecture can be implemented with various commercially available operating systems or combinations of operating systems (e.g., as virtual machines).

The aforementioned applications 1022, modules 1024, and data 1026 can include the computer-implemented system 100, the data component 102, the organized data set 104, the output component 106, the non-image indicators 108, and the data values 110 of FIG. 1, the range of audible tones 200, the variable frequency 202, the levels of tactile force resistance 204, the levels of visual brightness 206, and the customization component 208 of FIG. 2. The aforementioned applications 1022, modules 1024, and data 1026 can include the computer implemented system 300, the user interface component 302, and the data value 304 of FIG. 3, the computer-implemented system 400, the audio component 402, the user interface component 302, the numerical data value 404, the associated audible tone 406, the mapping component 408, the other sensory subsystems 410 and the associated sensory outputs 412 of FIG. 4, the mapping component 408, the audible tone maximum 502, and the audible tone minimum 504 of FIG. 5, and the methods of FIGS. 6-9, for example.

The storage subsystem(s) 1014 and memory subsystems (1006 and 1018) serve as computer readable media for volatile and non-volatile storage of data, data structures, computer-executable instructions, and so forth. Computer readable media can be any available media that can be accessed by the computer 1002 and includes volatile and non-volatile media, removable and non-removable media. For the computer 1002, the media accommodate the storage of data in any suitable digital format. It should be appreciated by those skilled in the art that other types of computer readable media can be employed such as zip drives, magnetic tape, flash memory cards, cartridges, and the like, for storing computer executable instructions for performing the novel methods of the disclosed architecture.

A user can interact with the computer 1002, programs, and data using external user input devices 1028 such as a keyboard and a mouse. Other external user input devices 1028 can include a microphone, an IR (infrared) remote control, a joystick, a game pad, camera recognition systems, a stylus pen, touch screen, gesture systems (e.g., eye movement, head movement, etc.), and/or the like. The user can interact with the computer 1002, programs, and data using onboard user input devices 1030 such a touchpad, microphone, keyboard, etc., where the computer 1002 is a portable computer, for example. These and other input devices are connected to the processing unit(s) 1004 through input/output (I/O) device interface(s) 1032 via the system bus 1008, but can be connected by other interfaces such as a parallel port, IEEE 1394 serial port, a game port, a USB port, an IR interface, etc. The I/O device interface(s) 1032 also facilitate the use of output peripherals 1034 such as printers, audio devices, camera devices, and so on, such as a sound card and/or onboard audio processing capability.

One or more graphics interface(s) 1036 (also commonly referred to as a graphics processing unit (GPU)) provide graphics and video signals between the computer 1002 and external display(s) 1038 (e.g., LCD, plasma) and/or onboard displays 1040 (e.g., for portable computer). The graphics interface(s) 1036 can also be manufactured as part of the computer system board.

The computer 1002 can operate in a networked environment (e.g., IP) using logical connections via a wire/wireless communications subsystem 1042 to one or more networks and/or other computers. The other computers can include workstations, servers, routers, personal computers, microprocessor-based entertainment appliance, a peer device or other common network node, and typically include many or all of the elements described relative to the computer 1002. The logical connections can include wire/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 1002 connects to the network via a wire/wireless communication subsystem 1042 (e.g., a network interface adapter, onboard transceiver subsystem, etc.) to communicate with wire/wireless networks, wire/wireless printers, wire/wireless input devices 1044, and so on. The computer 1002 can include a modem or has other means for establishing communications over the network. In a networked environment, programs and data relative to the computer 1002 can be stored in the remote memory/storage device, as is associated with a distributed system. It will be appreciated that the network connections shown are exemplary and other means of establishing a communications link between the computers can be used.

The computer 1002 is operable to communicate with wire/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

The illustrated aspects can also be practiced in distributed computing environments where certain tasks are performed by remote processing devices that are linked through a communications network. In a distributed computing environment, program modules can be located in local and/or remote storage and/or memory system.

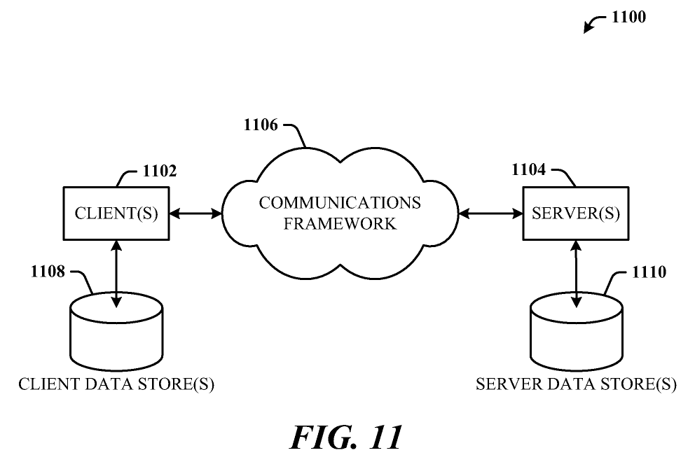

Referring now to FIG. 11, there is illustrated a schematic block diagram of a computing environment 1100 that can be used for communicating data values. The environment 1100 includes one or more client(s) 1102. The client(s) 1102 can be hardware and/or software (e.g., threads, processes, computing devices). The client(s) 1102 can house cookie(s) and/or associated contextual information, for example.

The environment 1100 also includes one or more server(s) 1104. The server(s) 1104 can also be hardware and/or software (e.g., threads, processes, computing devices). The servers 1104 can house threads to perform transformations by employing the architecture, for example. One possible communication between a client 1102 and a server 1104 can be in the form of a data packet adapted to be transmitted between two or more computer processes. The data packet may include a cookie and/or associated contextual information, for example. The environment 1100 includes a communication framework 1106 (e.g., a global communication network such as the Internet) that can be employed to facilitate communications between the client(s) 1102 and the server(s) 1104.

Communications can be facilitated via a wire (including optical fiber) and/or wireless technology. The client(s) 1102 are operatively connected to one or more client data store(s) 1108 that can be employed to store information local to the client(s) 1102 (e.g., cookie(s) and/or associated contextual information). Similarly, the server(s) 1104 are operatively connected to one or more server data store(s) 1110 that can be employed to store information local to the servers 1104.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented system for communicating data values, comprising:
a data component for receiving an organized data set; and
an output component for outputting a range of non-image indicators corresponding to data values of the organized data set.

2. The system of claim 1, wherein the range of non-image indicators is selected from at least one of audible tones, tactile vibrational frequencies, tactile force resistance levels, or visual brightness variation levels.

3. The system of claim 1, wherein the organized data set includes data values represented in at least one of a table, a bar graph, a pie chart, or a periodically varying function.

4. The system of claim 1, further comprising a user interface component for presenting and selecting a numerical data value to be presented as a corresponding non-image indicator.

5. The system of claim 1, further comprising a mapping component for mapping the data values to the range of non-image indicators.

6. The system of claim 1, wherein the output component is configured to assist visually impaired users in interpreting the organized data set.

7. The system of claim 1, further comprising a customization component for customizing the range of non-image indicators based on user requirements.

8. The system of claim 1, wherein the data component and output component are part of a client software module of a client device and the data component receives the organized data set from software applications residing on the client device for selection and mapping over a range of sensory outputs.

9. The system of claim 1, wherein the data component and output component are part of a software module that resides on a server.

10. A computer-implemented system for communicating data values, comprising:
a data component for receiving an organized data set of data values;
a mapping component for mapping for mapping the data values to a range of audible tones;
an audio component for generating the audible tones corresponding to the mapped data values; and
a user interface component for presenting the organized data set and interacting with a data value to output an associated audible tone.

11. The system of claim 10, wherein the mapping component maps a spread of audible tones across a range of maximum and minimum data values.

12. The system of claim 10, wherein the mapping component assigns a tonal separation between adjacent data points for a user to discern a variation in pitch.

13. The system of claim 10, wherein the audible tone for a data point is computed according to a frequency span applied to a range of data values, the data point a normalized data value relative to a minimum data value of the range of data values.

14. The system of claim 10, wherein the audible tones correspond to a range of notes associated with a piano keyboard.

15. A computer-implemented method of communicating data values, comprising:
receiving an organized data set; and
generating audible tones corresponding to data values within the organized data set.

16. The method of claim 15, wherein, prior to generating, further comprising assigning a spread of audible tones across a range between a maximum and a minimum.

17. The method of claim 16, wherein assigning the spread further comprises calculating a tonal separation between the audible tones sufficient for a user to discern a pitch variation.

18. The method of claim 15, wherein, prior to generating, further comprising assigning frequencies for the audible tones wherein a frequency of each audible tone represents a sum of a minimum audible tone frequency and a maximum audible tone frequency divided by an offset to produce a normalized value between a minimum data value and a maximum data value.

19. The method of claim 15, wherein receiving the organized data set further comprises displaying the organized data set and selecting a numerical data value from the organized data set using a user interface component.

20. The method of claim 15, further comprising customizing a range of audible tones to user requirements.
